(19) United States
(12) Patent Application Publication
(10) Pub. No.: US 2023/0410234 A1
(43) Pub. Date: Dec. 21, 2023

(54) SYSTEMS AND METHODS FOR MANAGING FAMILY LAW OBLIGATIONS

(71) Applicant: COME TO AGREEMENT LTD., Richmond Hill (CA)

(72) Inventor: Stephen ROSENFIELD, Richmond Hill (CA)

(21) Appl. No.: 18/037,580

(22) PCT Filed: Nov. 23, 2021
(86) PCT No.: PCT/CA2021/051660

§ 371 Date: May 18, 2023

Related U.S. Application Data
(60) Provisional application No. 63/116,942, filed on Nov. 23, 2020.

(51) Int. Cl. G06Q 50/18; G06Q 40/08

(52) U.S. Cl. CPC G06Q 50/182; G06Q 40/08

(57) ABSTRACT

A system and method for managing family law obligations with respect to a settlement agreement including providing and updating a rebalancing beneficiaries support insurance schedule that is connected with an insurance 5 policy. The system and method further includes modules for notifying parties to the settlement agreement when the insurance policy expires or when payment of an instalment of the insurance policy has not been made.

### CROSS-REFERENCE TO OTHER APPLICATION

The application claims priority from U.S. Provisional Application No. 63/116,942 filed Nov. 23, 2020 which is hereby incorporated by reference.

### TECHNICAL FIELD

The disclosure is generally directed at legal obligation management, and, in particular, to systems and methods for managing family law obligations.

### BACKGROUND

In the world of divorces and separations, the process is never simple. Often, child support or spousal support/alimony is never secured by the support payor to the support beneficiary. For those ex-spouses that do secure their support payments, such as with life insurance, the insurance method creates a variety of new legal issues that doesn't protect either ex-spouse. These legal issues include a) the beneficiary never knows if the policy will lapse despite legal clauses in the separation agreement; b) when the terms of the agreements are completed, the policy owner is often compelled to cancel a policy because the support beneficiary refuses to waive the irrevocability on the policy; and c) even though the amount of total agreed support reduces each time a support payment is made, the insured amount stays the same because it is too complex for any existing life insurance product to ascertain the continually changing amount owed to the support beneficiary.

Family law issues are complicated for a variety of reasons, whether due to financial reimbursements between the 2 ex-spouses, or determining children's residential schedules with each parent, or which parent is responsible for taking a child or the children to an activity, or who keeps the children's important documents and records, etc. Often, children create additional problems by refusing to co-operate. Co-Parenting requires an assortment of communication tools for the co-parents and a variety of professionals to help the children and parents with daily or ongoing problems.

Therefore, there is provided a novel system and method of managing family law obligations.

### SUMMARY

According to an aspect herein, there is provided a system and method for providing a Rebalancing Beneficiaries Support Insurance (RBSI) policy as described herein.

According to an aspect herein, there is provided a money management system as described substantially herein.

According to an aspect herein, there is provided a parenting schedule system as described substantially herein.

According to an aspect herein, there is provided a system comprising a suite of specific collaboration modules as described herein.

According to another aspect of the disclosure, there is provided, a method of managing family law obligations including receiving a settlement agreement; determining payment details based on the settlement agreement; and issuing an insurance policy based on the payment details.

In another aspect, determining payment details based on the settlement agreement includes calculating a rebalancing beneficiaries support insurance (RBSI) payment schedule. In a further aspect, the method includes updating the RBSI payment schedule on a regular basis or in response to actions being performed. In another aspect, the regular basis is weekly, monthly, bi-annually or annually. In yet another aspect, actions being performed include payments not made, removal of beneficiary from the settlement agreement or new expenses associated with the settlement agreement. In yet a further aspect, the method includes issuing an irrevocability waiver; and receiving a signed irrevocability waiver. In yet another aspect, the method includes monitoring status of the insurance policy; determining expiry of beneficiary support; and notifying a policy owner that the insurance policy may be updated.

In another aspect, the method further includes monitoring status of the insurance policy; and determining a payment for the insurance policy has been missed. In yet another aspect, the method includes notifying policy owner of missed payment. In another aspect, the method includes notifying support beneficiary of missed payment. In yet a further aspect, the method includes monitoring status of the insurance policy; receiving payment from a policy owner; and displaying payment within system for users to view. In yet another aspect, the method includes, before receiving a settlement agreement, receiving financial details from a user; calculating a set of preliminary total support amounts; and transmitting the set of preliminary support amounts to the user.

In another aspect of the disclosure, there is provided a system for managing separated families including a calendar module for displaying family member schedules enabling family members to co-ordinate schedules; and a money manager module for providing an overview of all expenses for all family members.

In another aspect, the money manager module includes a reimbursement module for tracking payments between family members; and an expenses module for creating expenses to be viewed by selected family member. In a further aspect, the money manager module tracks expenses and payments between family members. In yet another aspect, the system includes at least one of a contacts module, a children's information module, a school planner module, a notes module, a homework manager module, a media center module and a documents module. In yet another aspect, calculating the RBSI schedule includes determining an amount of time children spend with each parent; and calculating the RBSI schedule on the amount of time children spend with each parent. In yet another aspect, information relating to the amount of time children spend with each parent is retrieved from a family management system.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIGS. 1 to 3 provide schematic diagrams of a method of managing family law obligations through insurance;

FIG. 4 is a schematic diagram of a system for managing separated families;

FIG. 5 is a schematic diagram of a calendar module;

FIG. 6 is a schematic diagram of a contacts module;

FIG. 7 is a schematic diagram of a money manager module;

FIG. 8 is a schematic diagram of a notes module;

FIG. 9 is a schematic diagram of a children's info module;

FIG. 10 is a schematic diagram of a school planner module;

FIG. 11 is a schematic diagram of a homework manager module;

FIG. 12 is a schematic diagram of a media centre module;

FIG. 13 is a schematic diagram of a documents module;

FIGS. 14a and 14b are charts showing an embodiment of support insurance calculations; and

FIGS. 15a to 15f are tables showing an embodiment of rebalancing beneficiary support insurance schedule.

### DETAILED DESCRIPTION

Various apparatuses or processes will be described below to provide an example of an embodiment of the disclosure. No embodiment described below limits the disclosure and may cover processes or apparatuses that are not described below. The disclosure is not limited to apparatuses or processes having all of the features of any one apparatus or process described below or to features common to multiple or all of the apparatuses described below. The applicants, inventors or owners reserve all rights that they may have in any subject matter disclosed in an apparatus or process described below that is not claimed in this document, for example the right to claim such an invention in a continuing application and do not intend to abandon, disclaim or dedicate to the public any such invention by its disclosure in this document.

The disclosure addresses at least one of several issues relating to family law legal matters. In one embodiment, the disclosure is directed at a method and system for providing a rebalancing beneficiaries support insurance product. In one embodiment, the disclosure provides, develops, or generates a family law solution in combination with an insurance law solution to address these legal matters. These legal matters may include, but are not limited to:
a) Support payments for child support, children's expenses, spousal support/alimony or other agreed to expenses between ex-spouses: These payments are typically agreed to as a declining balance from a legal standpoint. Therefore, when support payments are paid, the total debt owed is reduced. In one embodiment, the disclosure addresses this legal matter by generating an automated schedule, such as via an insurance calculator component or module, for use by family law professionals or co-parents to solve the debt issue, whether the debt reduces as a fixed amount, as a fixed percentage, or as a variable amount based upon the logistical legal needs of that family unit, such as: children who are no longer considered children of the marriage and are no longer requiring support or schooling costs that need to be budgeted for. In one embodiment, children who are no longer considered “children of the marriage” and no longer requiring child support or support for university costs, are withheld from the calculation. A component of the system of the disclosure, which may be seen as a beneficiaries automated support insurance calculator/support insurance beneficiaries schedule determination component provides opportunities for family law professionals to creatively solve family law problems using the disclosure. When each party to the separation agreement executes, or agrees to, a support insurance beneficiaries schedule, it attaches to the insurance policy (such as a life insurance policy), thereby providing legal direction to the life insurance company such that family law and insurance law become co-mingled for the purposes of the insured party and/or the primary support beneficiary.
b) Releasing irrevocability on an insurance policy: In one embodiment of the disclosure, the support insurance beneficiaries schedule that is generated by the system of the disclosure provides a life insurance policy option that provides for the release of “irrevocability” status on the insurance policy used to secure the support payments. This solves complex family law and insurance law problems by legally incorporating “irrevocability” up front in the settlement agreement, as an attached schedule. While there are current legal clauses used in separation, or settlement agreements, the current wording does not tie family law to insurance law. In such cases, the primary support beneficiary becomes disadvantaged. This is addressed by the system and method of the disclosure as will be discussed below.
c) Lapse of insurance policies: The disclosure addresses the problem when insurance policies lapse and the support beneficiary is not made aware of the cancelled policy that secures the payments for the support beneficiary, by arranging for the notification to be incorporated in the solution upfront. In one embodiment, this may be implemented as a legal schedule in the separation agreement whereby the system and method of the disclosure acts as a servicing/support agent of record with the insurance carrier and the company or its licensed insurance advisor can notify the support beneficiary in advance of the policy lapse, if agreed to on the schedule.

In one embodiment, an output of the system and method of the disclosure provides flexibility to accommodate any combination of insurance needs, reflecting the uniqueness of every family going through a divorce or separation situation.

In another embodiment of the disclosure, the disclosure enables an insurance policy owner, the primary support beneficiary (if different than the policy owner) and the insurance carrier/insurance provider, to share insurance policy schedules for the benefit of all parties to the separation agreement, divorce order or court order and the like.

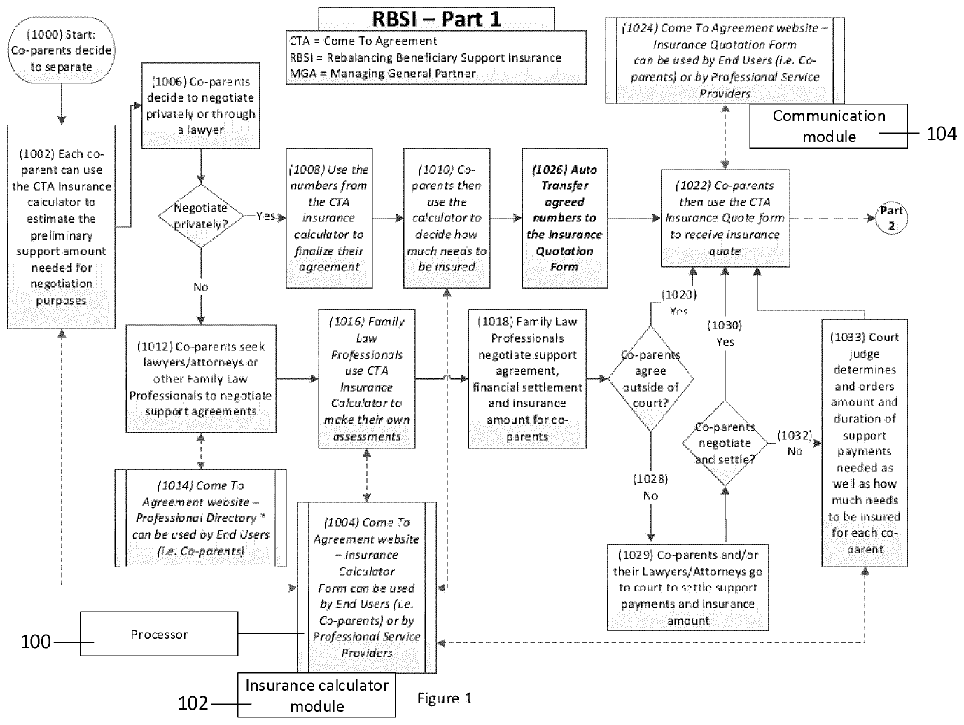

Turning to FIGS. 1 to 3, an embodiment of a method and system of managing family law obligations is shown. In one embodiment, the disclosure includes generating a rebalancing beneficiaries support insurance solution. The system may include a processor 100 that performs processing for the system. The processor may store modules for execution of different functionalities, such as discussed below, or communicates with modules for executing the different functionalities. The system may also be seen as a computer readable medium that includes code that, when executed, enables the system to provide a method and system for managing family law obligations.

Prior to accessing the system, the external parties may undergo, or perform certain preparatory actions such that when they access the system, they are able to input separation details, or data, which are received by the system for processing. Examples of separation details, or data, may include, but are not limited to, settlement agreement details, personal financial details, personal contact information, and list of beneficiaries. These certain actions that are performed prior to inputting the details into the system do not form part of the innovation but provide examples of how information for use by the system may be generated. Examples of external parties include, but are not limited to, family law professionals, insurance brokers, insurance advisors, insurance carriers and separated co-parents.

As shown in FIG. 1, the preparatory process may commence when co-parents decide to separate, triggering a support journey negotiation phase (1000). One of the things that co-parents will start to worry about is how much support payments would be needed to cover future expenses. Each or either co-parent may then access the system to input financial details into the system (1002) to have the system estimate a preliminary total support amount the individual feels would be suitable, before negotiations with the other co-parent begins. The financial details may include the income of either or both of the co-parents or a listing of expected/future expenses for beneficiaries. After receiving the financial details, the system (such as via an insurance/support calculator) processes the financial details (1004). In one embodiment, the insurance calculator may be implemented as an insurance calculator module 102 that is either stored within the processor 100 or stored external to the processor 100 and communicates with the processor 100.

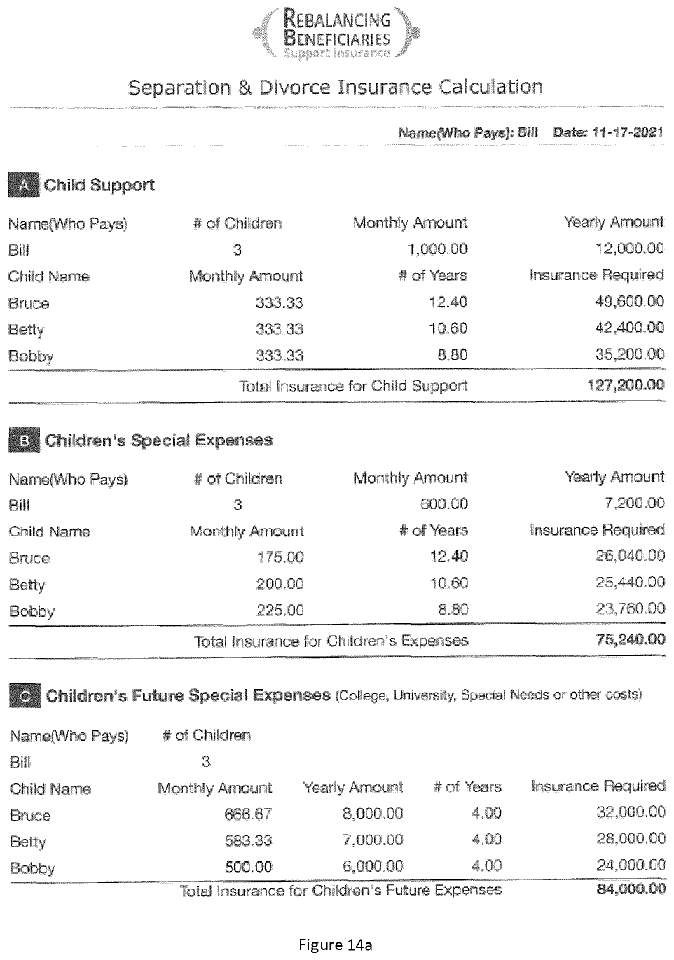

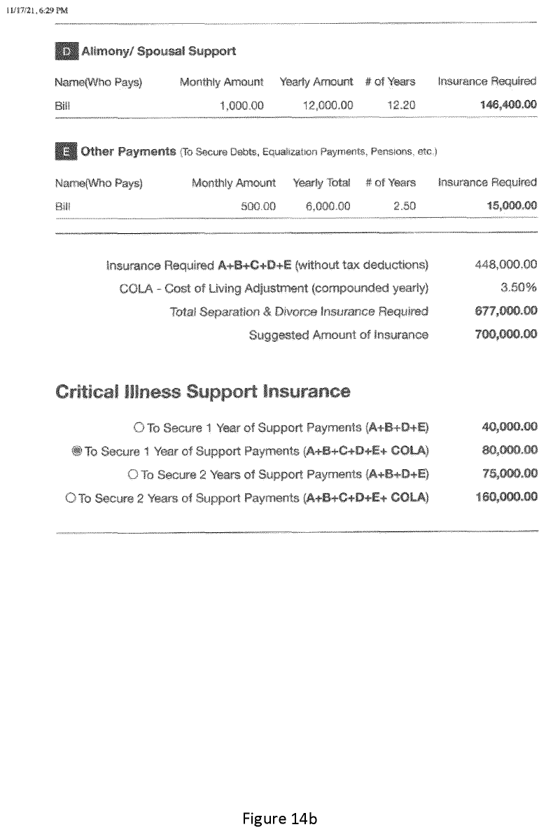

After receiving the financial details, the system generates a set of preliminary total support amounts for the user. A table showing preliminary total support amounts is provided in FIGS. 14a and 14b. As shown in the embodiment of FIGS. 14a and 14b, the insurance calculator generates or calculates estimates for monthly or yearly amounts for Part A—Child Support and Part D—Spousal Support/Alimony. Alternatively, these may be part of the financial details provided by the user. Parts B and C are calculated by the insurance calculator based on the needs of each individual child who may have special needs or requirements (based on the submitted financial details). Part E may be calculated or generated by the insurance calculator based on debt or equalization payments to be made to the beneficiary party, as negotiated in the agreement or for any monies owed to that beneficiary's family members.

The co-parents may then enter into negotiations with respect to the creation or development of a separation, or settlement agreement (1006). This may be performed between the co-parents or other parties, such as family law professionals or mediators. If the parents decide to negotiate privately, the co-parents may use the set of preliminary total support amounts determined by the system on which the settlement agreement is based (1008). Based on the settlement agreement, the co-parents may then re-engage the system to calculate an amount to be insured (1010), using the system to process (1004) further financial details. The insurance/support calculator 102 (or the processor 100) may then calculate the amount to be insured. As shown in FIGS. 14a and 14b, the calculations generated by the insurance calculator extends the estimated or agreed to total support payments for the children, based upon an agreed to duration of support required for each individual child. Spousal support/alimony may be based upon the duration of the required support and the total amount is calculated. Debt or equalization payments may also be totalled and a total life insurance amount is calculated, COLA (Cost of Living Adjustment) is added to the total amount of life insurance, and then total separation & divorce insurance required is calculated and rounded up to a typical insurance policy amount. Critical illness Insurance may also be calculated to provide an additional option so the policy owner can continue to make support payments, as agreed to, in the event of serious illness.

If the co-parents decide to negotiate with family law professionals, such as, but not limited to, lawyers or mediators (1012) to generate the settlement agreement, the system, such as via the processor, may provide users with a list of family law professionals (1014). In one embodiment, the system may retrieve a listing of family law professionals that are stored in a database and display this list to the user.

Once engaged with family law professionals, the family law professionals may engage with the system (1016) to have the system process (1004) financial details such as discussed above. For example, the system, via the insurance/support calculator 102, may then determine what support payments should be covered and/or calculate the amount to be insured.

After obtaining the calculations or results from the system, the family law professionals may negotiate or generate a separation agreement, a financial settlement and/or insurance amounts (1018). If the terms can be agreed upon (1020), the external parties may access the system to request an insurance quote (1022). Similarly, the co-parents, after requesting and receiving the amount to be insured in (1010), may also access the system to request an insurance quote (1022). The system then communicates with the insurance advisor and the company to provide a quote for insurance (1024). In one embodiment, the processor 100 may transmit a message to at least one insurance broker/company requesting a quote for an insurance policy based on preliminary support amounts. In another embodiment, communication between the system and the insurance broker/company/carrier may be via a communication module 104. In some embodiments, the preliminary support amounts that are previously generated may be auto-transferred (such as by the processor 100) to be used by the system to generate the insurance quote (1026).

If terms are not agreed upon (1028), the co-parents and family law professionals may have to go to court to settle the negotiations and generate a settlement agreement to determine if a settlement can be negotiated and settled (1029). If a settlement agreement is negotiated (1030), the external parties may access the system to request an insurance quote (1022). If a settlement agreement cannot be negotiated via the courts (1032), a settlement agreement may be determined by the courts (1033). This may be performed with assistance from the system (such as via the insurance/settlement calculator) to generate amounts for the court determined settlement agreement. The external parties may then access the system to request an insurance quote (1022).

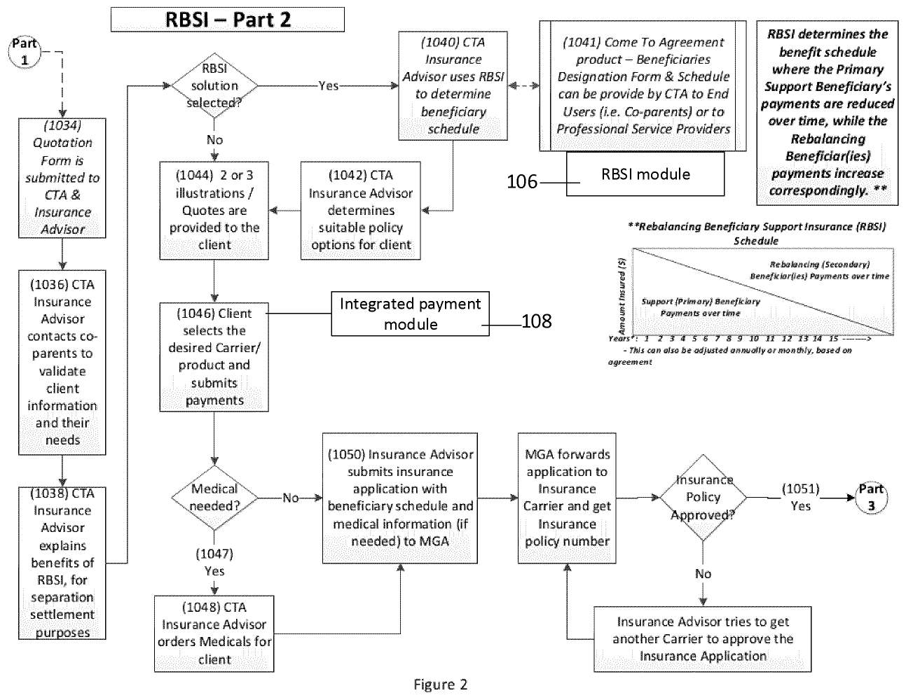

Turning to FIG. 2, after receiving a request for an insurance quote (1034), the system or an individual associated with the system may validate the client information and review/analyse/process the request for the insurance quote (1036). If performed by the system, the processor 100 may process the received information and compare it with information that is stored in a database to validate the received information. The individual associated with the system or the system may then propose a rebalancing beneficiaries support insurance (RBSI) solution to the external parties (1038). The RBSI functionality of the disclosure will be described in more detail below. If the external parties decide to use the RBSI solution, or functionality, the individual associated with the system or the system itself may then generate a beneficiary schedule (1040). In one embodiment, the system, such as via the processor 100 or a RBSI module 106 that is either stored within the processor 100 or external to the processor generates an RBSI schedule based on previously received financial details and/or the settlement agreement. In another embodiment, the RBSI schedule is generated based on family law regulations. In another embodiment, the RBSI schedule is generated based on the amount of time children spend with each parent. This information may be input into the system by an external party or may be retrieved from a parenting schedule, calendar module or other module of a family management system such as disclosed below.

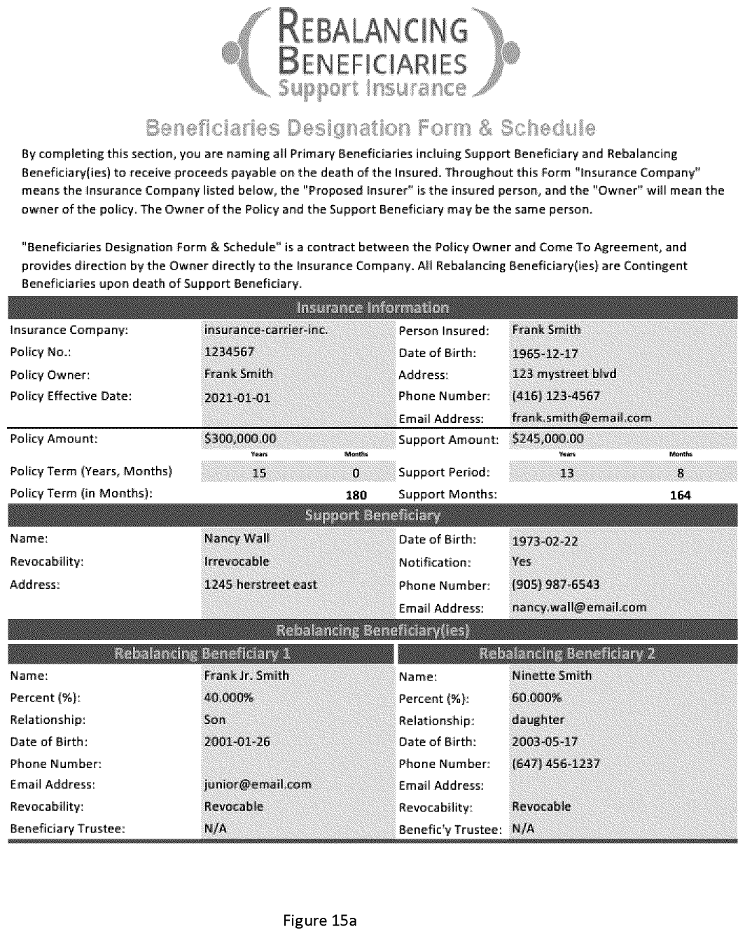

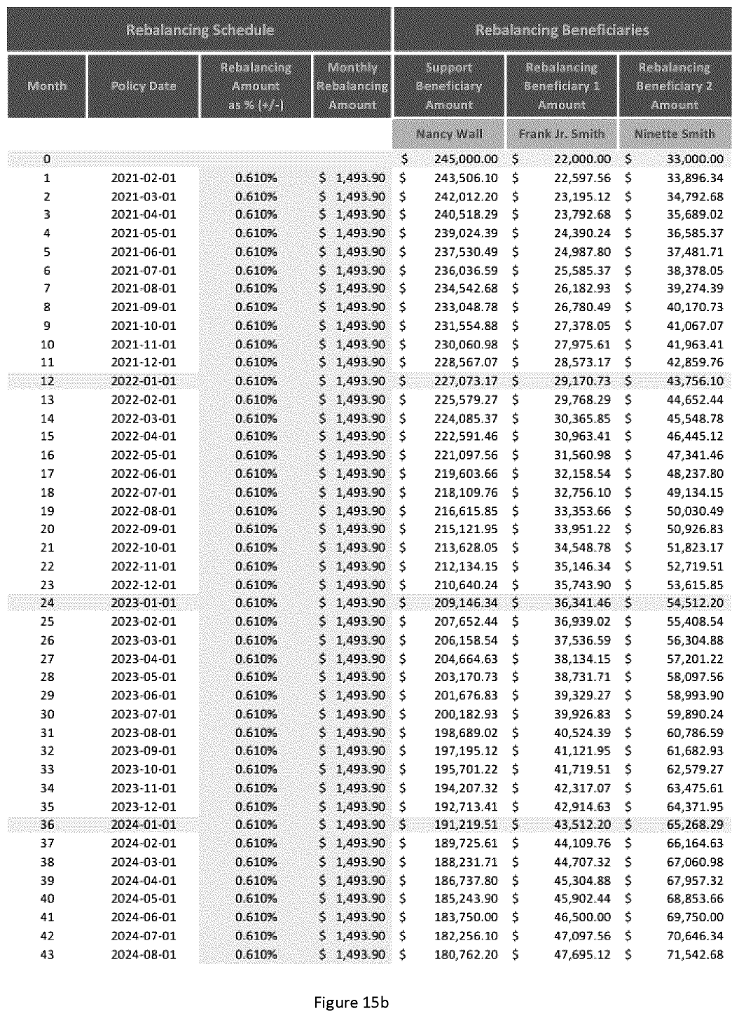

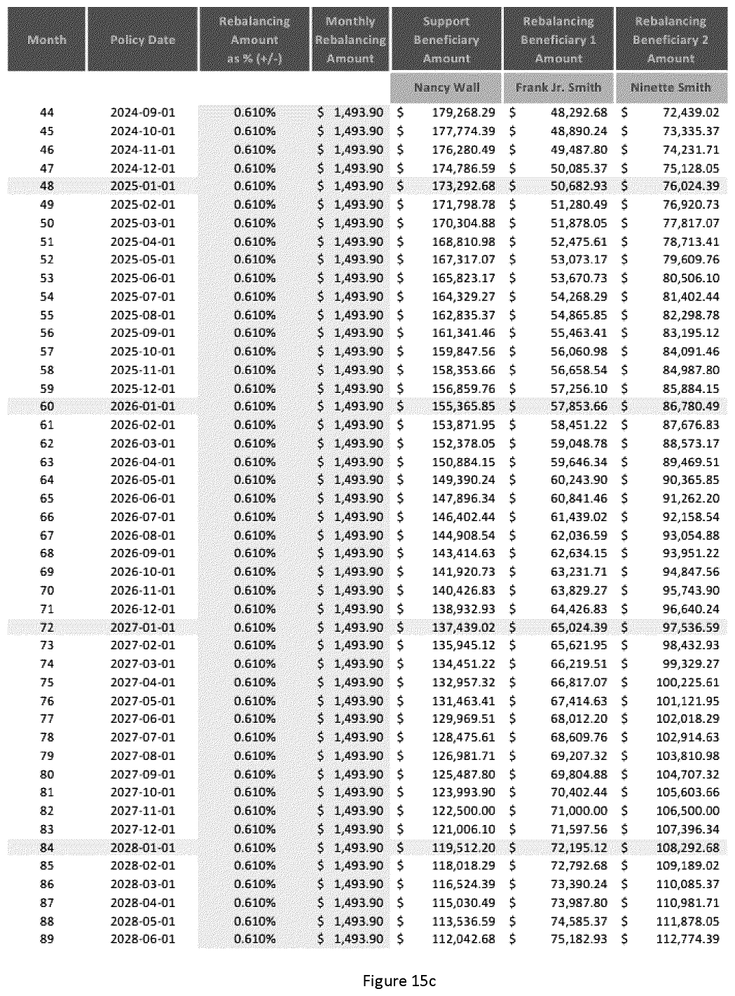

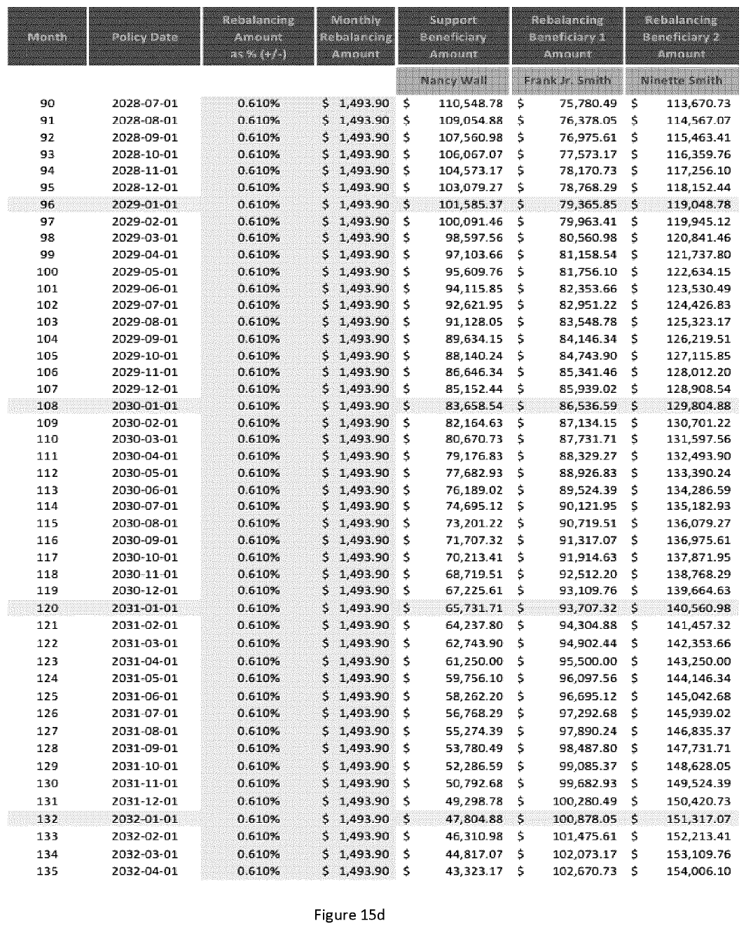

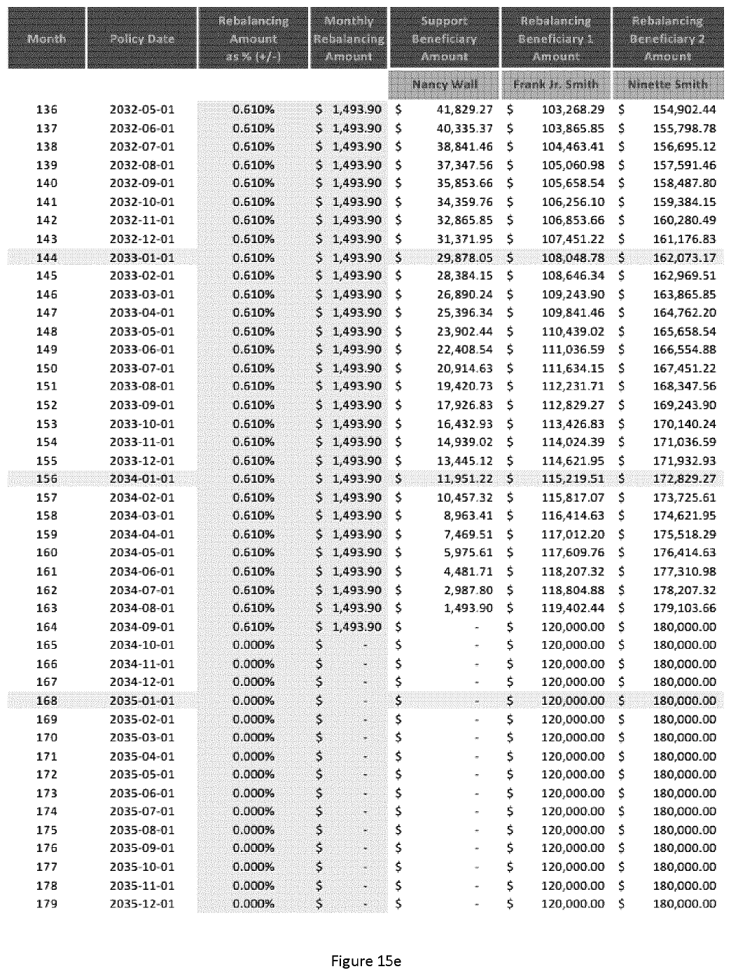

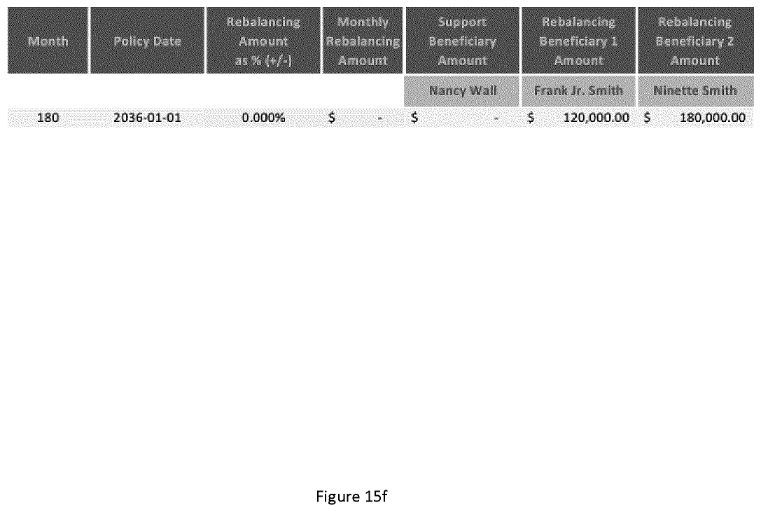

An example of sample of a RBSI schedule that may be generated by the system (1041) is shown in FIGS. 15a to 15f. In one embodiment, the RBSI module generates or determines a benefit schedule where the primary support beneficiary's payments are reduced over time while the rebalancing beneficiary or beneficiaries payments increase correspondingly. Updates to the schedule may be performed when requested by a user; or based on certain actions occurring. The individual associated with the system or the system may then determine suitable insurance policy options for the external parties (1042). The licensed insurance advisor then obtains quotes for the insurance policy and then submits them to the external parties (1044).

If the external parties do not wish to use the RBSI solution, the system contacts insurance brokers to obtain quotes for the insurance policy and then submits them to the external parties (1044). This may be performed by the system transmitting the received quotes to the external parties. The system then receives a selection from the external parties (1046). This selection may include the carrier and desired insurance product. Upon receipt of the select, the processor may store this in a database. The system may also receive and process an initial payment from the external parties through an integrated payment gateway module 108. Payments to the integrated gateway module may be displayed for all users so that they may track when payments are made.

If a medical is required (1047), one is ordered (1048) and performed and the results may be inputted into the system (and stored by the system). The system or an individual associated with the system then submits an insurance application with a beneficiary schedule and medical information, if necessary (1050) to the selected insurance carrier. If no medical is necessary or required, the system or an individual associated with the system then submits an insurance application with a beneficiary schedule (1050) to the insurance carrier whereby a policy is approved and issued (1051).

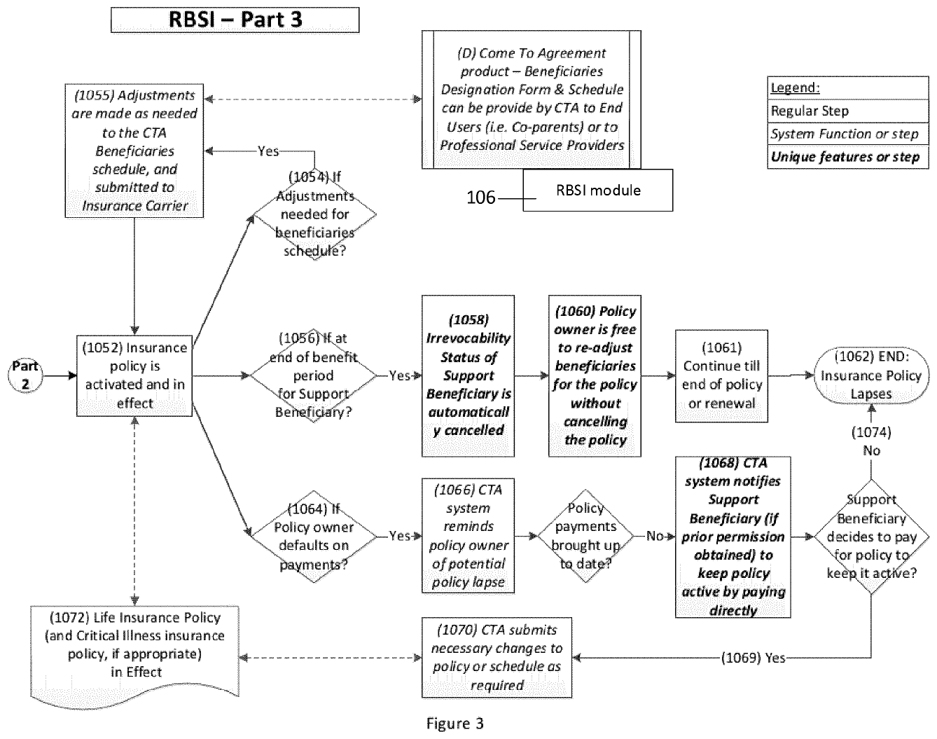

Turning to FIG. 3, once a policy is issued (1052), changes may be necessary for different reasons. After a period of time of the policy being issued, or valid, different scenarios may arise. For example, adjustments to the support insurance beneficiaries schedule, may be required (1054). In one embodiment, the system may determine that changes to the beneficiaries schedule is required or this may be determined by one of the external parties. The system, such as via the RBSI module 106, or an individual associated with the system may then re-calculate or re-generate the beneficiaries schedule and submits it to the insurance carrier (1055). Once the policy amendment or update is approved, the insurance policy is updated (and re-stored by the system) and continues to be activated and in effect (1052).

In another embodiment, the support insurance beneficiaries schedule may be calculated on a monthly or yearly basis by the RBSI module 106. The “schedule” provides the flexibility to secure all future support payments owed to the support beneficiary at any point in time during the duration of the legal agreement. As well, it may provide specific life insurance payment requirements plus the increasing rebalancing allocations shown on the schedule to secondary rebalancing beneficiaries such as children or a new spouse. The support payments agreed to between the parties can be adjusted on a yearly basis if the needs of the settlement agreement specify adjustments based on changing child support payments or for increasing spousal support payments, as child support payments decrease. Also, appointed trustees can oversee the children's inheritance if the children are below the age required by the laws of that jurisdiction, or as specified by the parent in his or her will.

Alternatively, the benefit period for the support beneficiary may expire (1056). If this occurs, the irrevocability status of the support beneficiary is automatically cancelled by the system (1058). In one embodiment, the system may transmit a message to the policy owner with this information. The policy owner may then re-adjust the beneficiaries without having to cancel the policy (1060). If the policy owner decides to update the policy, the changes may be submitted to the system which then transmits these updates to the insurance carrier. The policy may then be updated and re-submitted back to the system to be stored where the policy may remain active (1061) and in effect until the insurance policy lapses (1062).

Alternatively, the policy owner may default on payments of the insurance policy (1064). The system or an individual associated with the system may then transmit a message or reminder to the policy owner regarding the missed payment (1066). If the policy owner pays the missed payment, the policy remains activated and in effect until it lapses. If the policy owner does not pay the missed payment, the system may notify the support beneficiary (1068) (assuming prior permission was granted) to see if the support beneficiary wishes to pick up the policy payment(s). If the support beneficiary decides to pay for the policy (1069), the insurance payment is updated by the system and the system transmits this message to the company and the insurance advisor to update the policy with the insurance carrier (1070). At any time, the system may interact with the external parties to determine if other amendments to the policy may be necessary such as, but not limited to, the addition of critical illness portion (1072). Payments from any parties may be made directly to the system and processed by the payment gateway 108 so that all users who have access to the system can see when, and if, payments are made.

If the support beneficiary decides not to pay the policy payments (1074), the policy lapses (1062).

One advantage of the system of the disclosure is a system and method that offers extensive flexibility to accommodate any combination of support insurance security, reflecting the uniqueness of every family going through a separation or divorce situation. The system and method of the disclosure provides a flexible system and adapts to most governmental policy changes.

Another advantage of the system is a system and method for support insurance calculation that provides flexibility to easily calculate the amount of support insurance required for most separated families. The system and method for support insurance calculation may provide calculations for children who require different amounts of support, for example: 1) a brilliant child who might go to medical school while their siblings may not go to college; 2) a disabled child who requires long-term support; and/or 3) a child who may have special skills and requires money spent to further those skills, such as music or sports. The system and method of support insurance calculation may also, automatically or when instructed, calculate for spousal support/alimony to be paid for longer periods of time and provides for flexible cost of living adjustments (COLA) calculated for inflation. The insurance calculator may have pre-stored values to adjust calculations for cost of living adjustments. The system and method for support insurance calculation may update calculations to adjust for critical illness insurance so support payments can continue if a person becomes sick, can't work and still needs to make support payments.

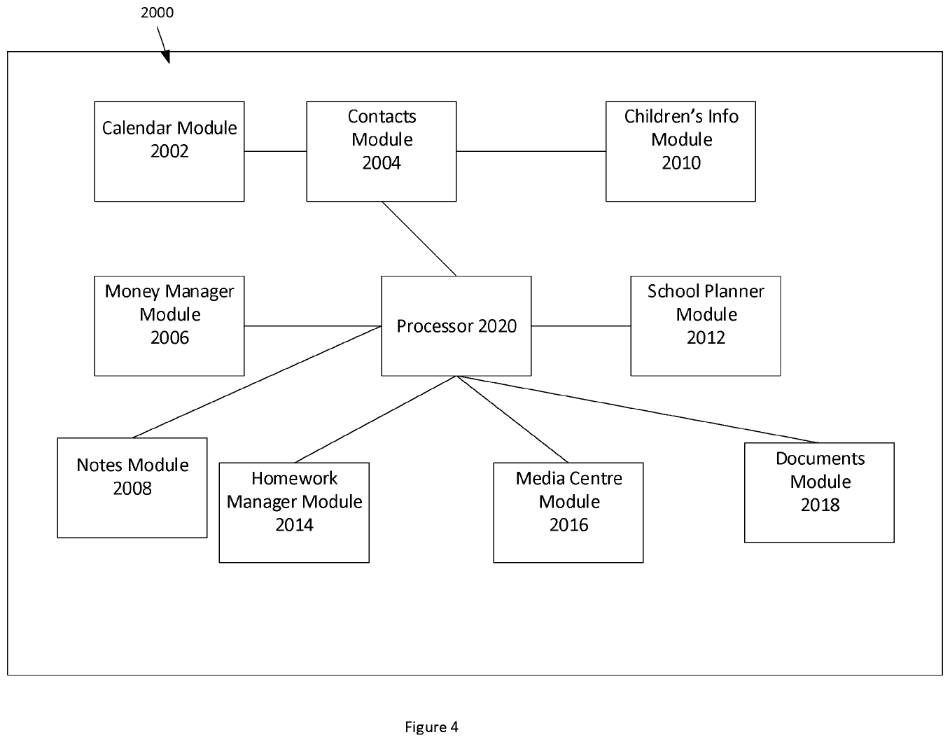

Turning to FIG. 4, a schematic diagram of a system for family management is shown. In one embodiment, the system for family management may be used by co-parents to manage the family information while being separated or divorced. In some scenarios, while communication between co-parents may be limited for a variety of reasons, the system provides a tool for family management where co-parents may communicate or be involved with their children's lives without needing to speak to the other parent. Certain aspects of the system may also be accessed by family law professionals, or other family members, to assist in maintaining help and support for families experiencing divorce or separation.

In the current embodiment, the system 2000 includes a calendar module 2002, a contacts module 2004, a money manager module 2006, a notes module 2008, a children's info module 2010, a school planner module 2012, a homework manager module 2014, a media center module 2016, a documents module 2018 and a processor 2020. Each of the modules are connected to, or a part of, the processor 2020 which may control or execute each of the modules or may provide instructions to each of the modules. Although not shown, the modules may also be connected to each other.

The calendar module 2002 allows users to review the schedules of family members in order to co-ordinate schedules so that the co-parents may keep track of their children's schedules and, of each other schedules (where necessary or allowed). The contacts module 2004 provides information to the user, that the user has access to, relating to the family contacts. The money manager module 2006 provides a module that provides an overview of all expenses that have been created and/or approved by the co-parents as well as payments that have been made. The notes module 2008 may provide a communication platform for users or co-parents to communicate with each other. The children's info module 2010 provides information associated with each child that is registered under the family management system. The school planner module 2012 provides school information associated with each child that is registered under the family management system. The homework manager module 2014 may provide information relating to the children's class schedules and/or homework for each class. The media center module 2016 may provide information relating to the media accessible by the user. The documents module 2018 may display all documents that are accessible by the user.

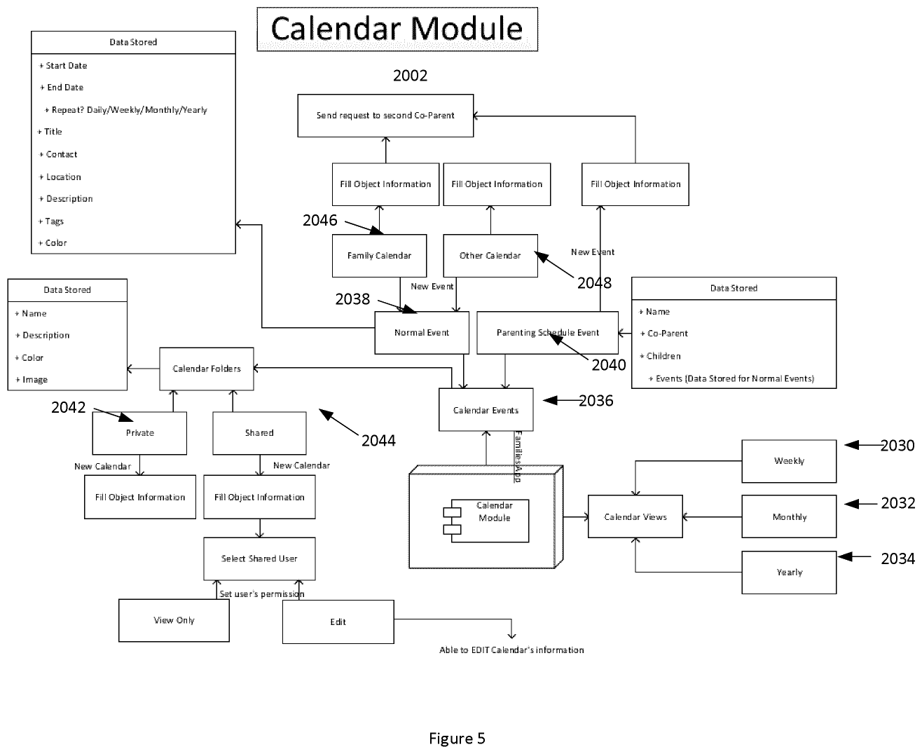

Turning to FIG. 5, a schematic diagram of one embodiment of a calendar module 2002 is shown. The calendar module 2002 enables a user to review the schedules of the family members. The calendar events may be viewed on a weekly 2030, monthly 2032 or yearly 2034 basis as requested by the user. The calendar module 2002 stores all of the calendar events 2036 in its database, or may retrieve these events that are stored in a separate database. The calendar events may be stored within a private calendar 2042 (viewable by only a single individual, or selectively shared with designated users) or in a shared calendar 2044 (viewable by designated individuals).

The calendar events 2036 may be normal events or parenting schedule events. Normal events 2038 may be seen as common events shown in the calendar display while parenting schedule events 2040 may be seen as events that are created using a parenting scheduling functionality that allows parenting events to be shown, in one embodiment, in a predetermined area within a display (such as at the top of the calendar display). In one embodiment, a normal event 2038 may include information such as, but not limited to, start date, end date, title, contact, location and/or description of the event. For a parenting schedule event, the system may transmit a message to the other co-parent to confirm that they are available for the parenting event.

The calendar module 2002 may also enable family calendars 2046 or other type calendars 2048 to be created or generated. In one embodiment, events for the family calendar may require approval from both parents before it can be added to the calendar. In an embodiment of the other type calendar, events may not require approval.

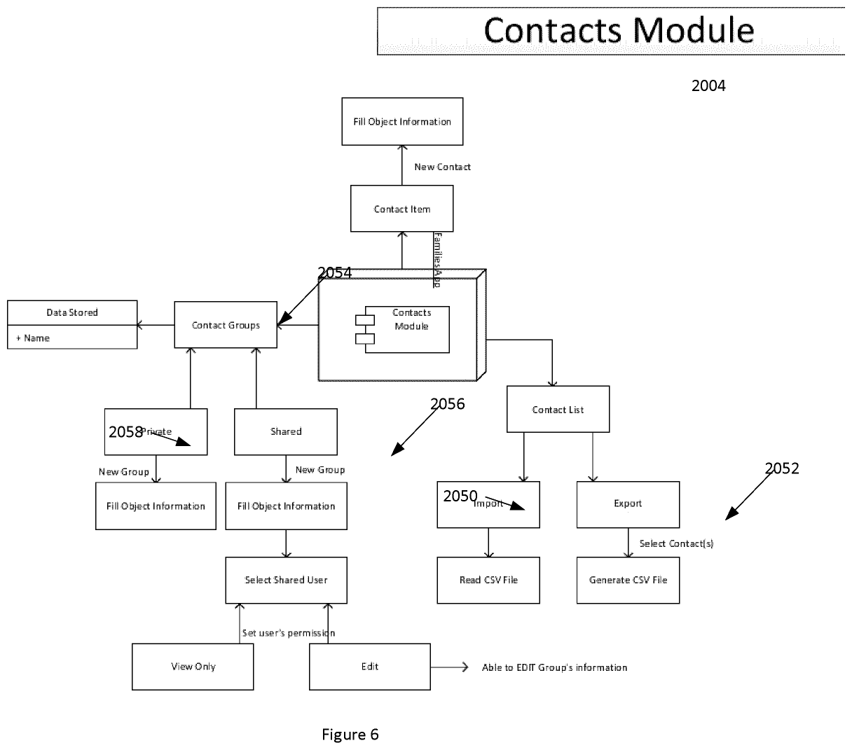

Turning to FIG. 6, a schematic diagram of one embodiment of a contacts module 2004 is shown. The contacts module 2004 enables a user to view stored contacts within the family management system. Examples of contacts may include, but are not limited to, teachers, coaches, neighbours and/or parents of children's friends. Contact lists may be imported 2050 or exported 2052 from the system, such as via a CSV file.

The contacts may also be placed in contact groups 2054 that may be placed in shared folders 2056 or private folders 2058. The shared contacts folders 2056 may include contacts that are shared between users of the system while the private contact group or folder 2058 may only be viewed by a single user or selectively shared with designated users. Individual contacts may also be shared or kept private. For instance, shared contacts may be contacts that are displayed to the user but are not in any of the folders associated with the user.

Contacts may also be created by users with information such as, but not limited to, contact information (such as personal information, work information, customized information fields). Events and contact notes may also be created/associated with the contacts.

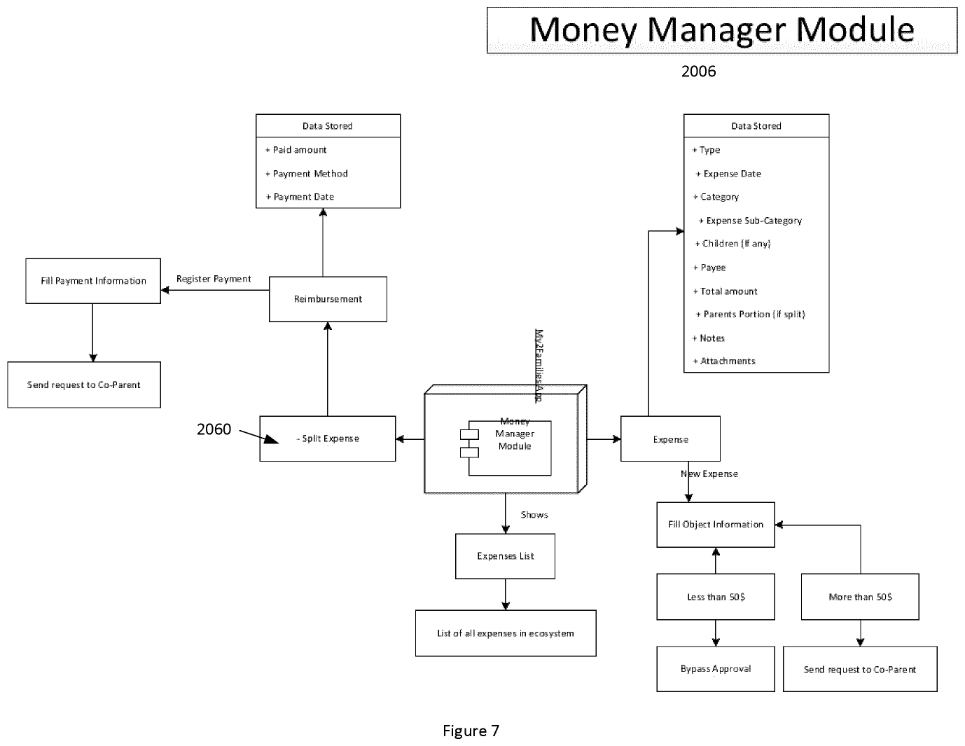

Turning to FIG. 7, a schematic diagram of one embodiment of a money manager module 2006 is shown. In one embodiment, the money manager module may be integrated with the payment gateway although they may also be distinct and separate components. The money manager module 2006 provides functionality to enable a user to monitor and track expenses and payment of expenses. The money manager may also enable users to view payments that have been made with respect to expenses or the insurance policy as outlined above. In one embodiment, the module 2006 enables users to settle up expenses (where one individual pays the entire expense) or to add a payment to an expense already created by another user. Different types of expenses may be created by a user. These expenses may include a split expense 2060 or a co-parent expense. A split expense may include one where one co-parent pays the expense and is reimbursed by the other co-parent or one where both co-parents pay their portion directly to a company or individual that is owed the expense. This may be tracked and monitored by the system. A co-parent expense may be one where one co-parent pays the whole amount and is fully reimbursed by the other co-parent or where one co-parent pays the full amount and the other co-parent is able to see the expense as part of the expense record. Reimbursements may be separated into two categories: normal reimbursement and co-parent payment. A normal reimbursement may be applied to a split expense where a co-parent reimburses the other co-parent. The system transmits a request or message to request reimbursement for the co-parent that paid the entire expense. A co-parent payment may be one where one co-parent is paid automatically for shared expenses.

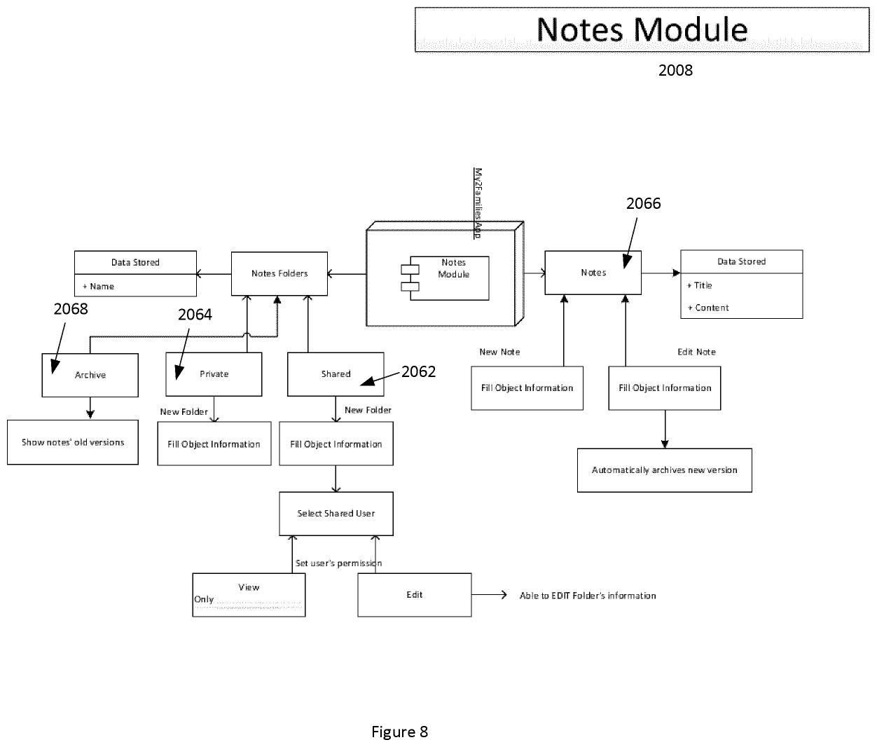

Turning to FIG. 8, a schematic diagram of one embodiment of a notes module 2008 is shown. The notes module 2008 enables notes (or messages) to be left between users of the system. In the current embodiment, the notes may be divided into four categories: shared notes folder 2062; private notes folder 2064, shared notes 2066 and archived notes or folders 2068. The shared notes folder 2062 is a folder that can be accessed by any of the users and includes notes for viewing by these users. The private notes folder 2066 is a folder that includes notes that can only be viewed by a single user, or selectively shared with designated users. The shared notes 2066 are notes that are viewable by a user but do not belong to any shared folder accessible by the user. The archived notes or folders 2068 are folders that include previous versions of all notes. In one embodiment, when a user creates a note, it is stored in a folder as determined by the user and a copy of the note is stored in the archived folder as well, as an ongoing record for each co-parent.

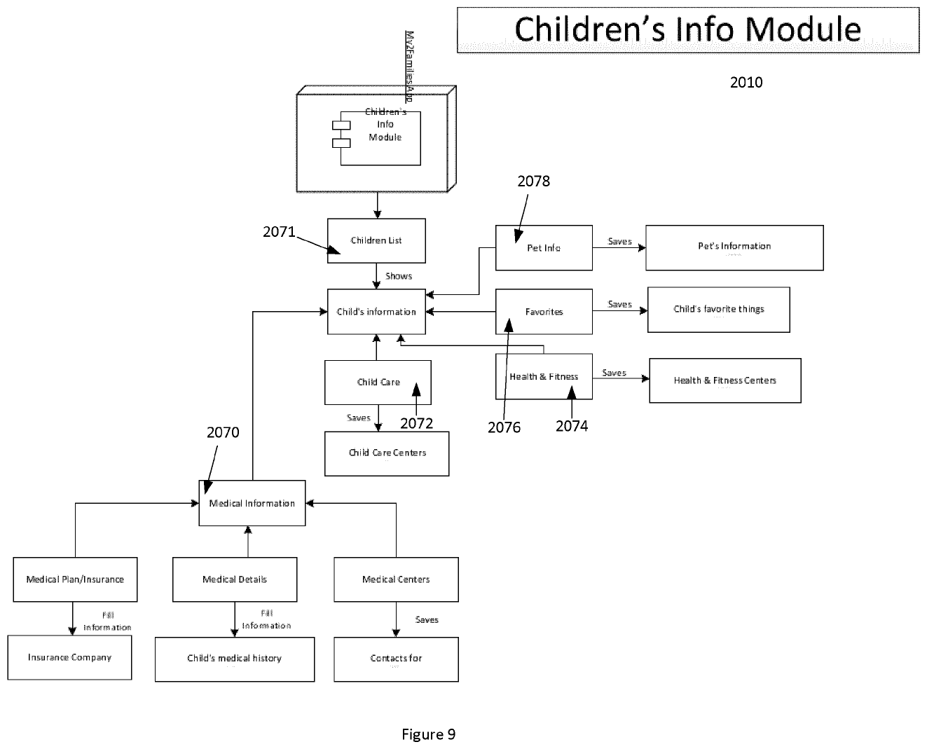

Turning to FIG. 9, a schematic diagram of one embodiment of a children's info module 2008 is shown. The children's info module 2008 may provide personal information associated with each of the children (2071) associated with the family. Further children information may include, but is not limited to, medical information 2070, child care information 2072, health & fitness information 2074, favourites information 2076 and/or pet information 2078.

The medical information 2070 may include medical plans/insurance information which includes insurance company information; medical details information which includes a child's clinical history and/or medical conditions; medical professional/center information which may include medical centers or professionals to be contacted in case of emergency; medical documents information which may include attachments relating to the child's health; and archived medical documents information which may include backup versions of medical documents. The child care information 2072 may include different contacts and notes about people related to the child's care. The health & fitness information 2074 may include different contacts, goals, details and attachments of any health & fitness programs that the child is a part of. The favourites information 2076 may include notes relating to things the child likes, such as TV shows, foods, music, or clothing and the like. The pet information 2078 may include all information relating to family pets such as, but not limited to, pet information, pet insurance, where to buy supplies and/or veterinarian contact information.

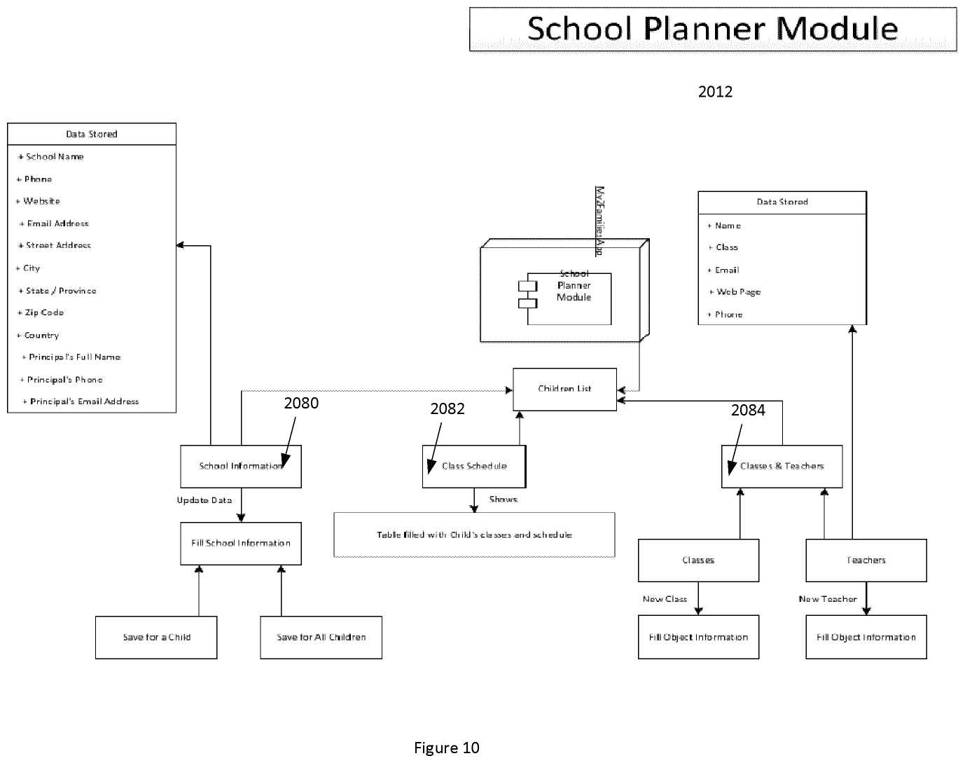

Turning to FIG. 10, a schematic diagram of one embodiment of a school planner module 2012 is shown. In one embodiment, the school planner module 2012 may provide school information associated with each of the children within the family. The school planner module 2012 may include school information 2080, class schedule information 2082, classes and teachers' information 2084.

The school information 2080 may include information such as the school address, the school webpage, contact phone information and/or principal information. The class schedule information 2082 may include a table that displays a calendar with the class schedule, and possibly after school curricular activities schedule of each child. The table may also be edited by users to include notes relating to the different class periods. The classes and teachers information 2084 may include information relating to a class subject and the teacher teaching that subject.

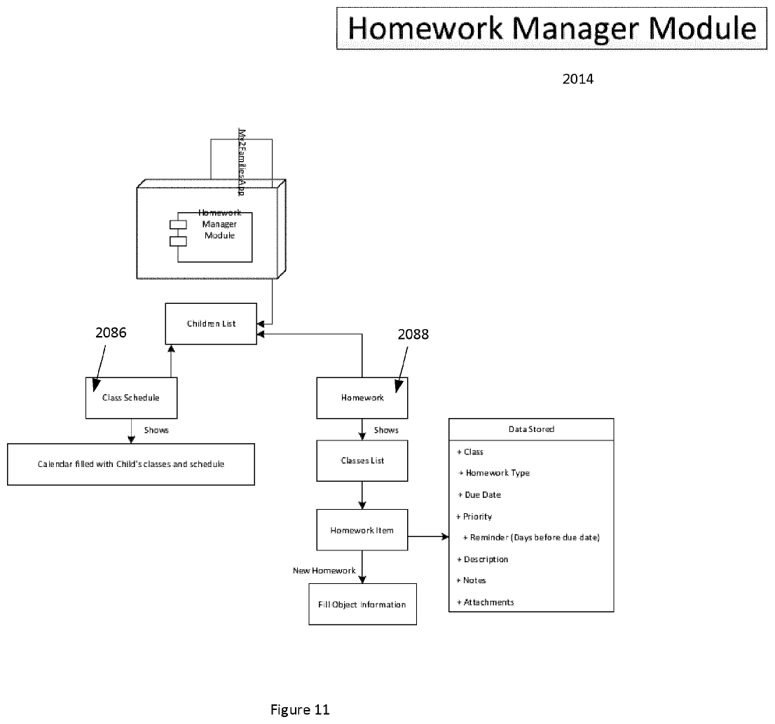

Turning to FIG. 11, a schematic diagram of one embodiment of a homework manager module 2014 is shown. In one embodiment, the system displays the homework information with respect to each child so that the co-parents can manage or track the homework for the children. In one embodiment, the system may display the class schedule 2086 and/or the homework 2088 for each child. Similar to the school planner module, the class schedule portion 2086 may include a table showing the child's class schedule and, possibly, the homework registered for the child on a per class basis. The homework portion 2088 may show a list of classes that the child is registered for, and all the homework associated with that class is displayed when selected by the user.

Homework may be registered, stored or input into the system via clicking on a class period and then inputting the homework for that class via the class schedule 2086 or by entering the information by selecting a class from the homework computer 2088 and then inputting the homework. Other ways to input homework are contemplated.

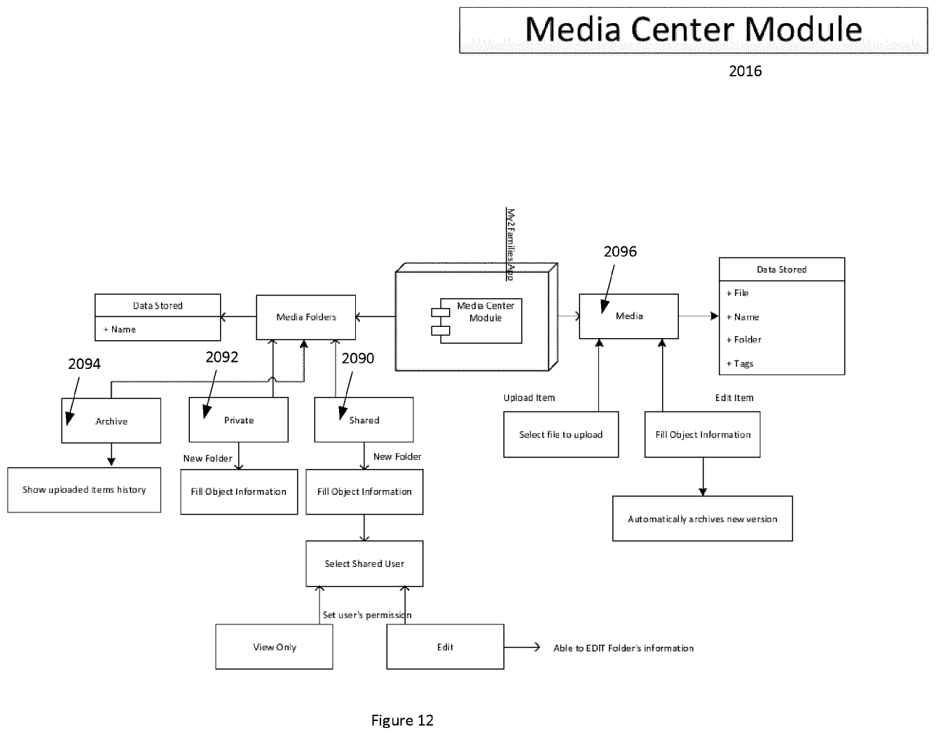

Turning to FIG. 12, a schematic diagram of one embodiment of a media center module 2016 is shown. The media center module 2016 may display all media that is accessible by the user. Media may include, photos, videos, blogs, or music. The media may be stored in a shared media folder 2090, a private media folder 2092, an archived media folder 2094 or as shared media 2096.

The shared media folder 2090 is a folder that can be accessed by any of the users and includes media for viewing by these users. The private media folder 2092 is a folder that includes media that can only be viewed by a single user, or selectively shared with designated users. The shared media 2096 is individual media files that are viewable by a user but do not belong to any shared folder accessible by the user. The archived media folder or media folders 2094 are folders that include previous versions of stored media. In one embodiment, when a user uploads media, it is stored in a folder as determined by the user and a copy of the media may be stored in the archived media folder as well.

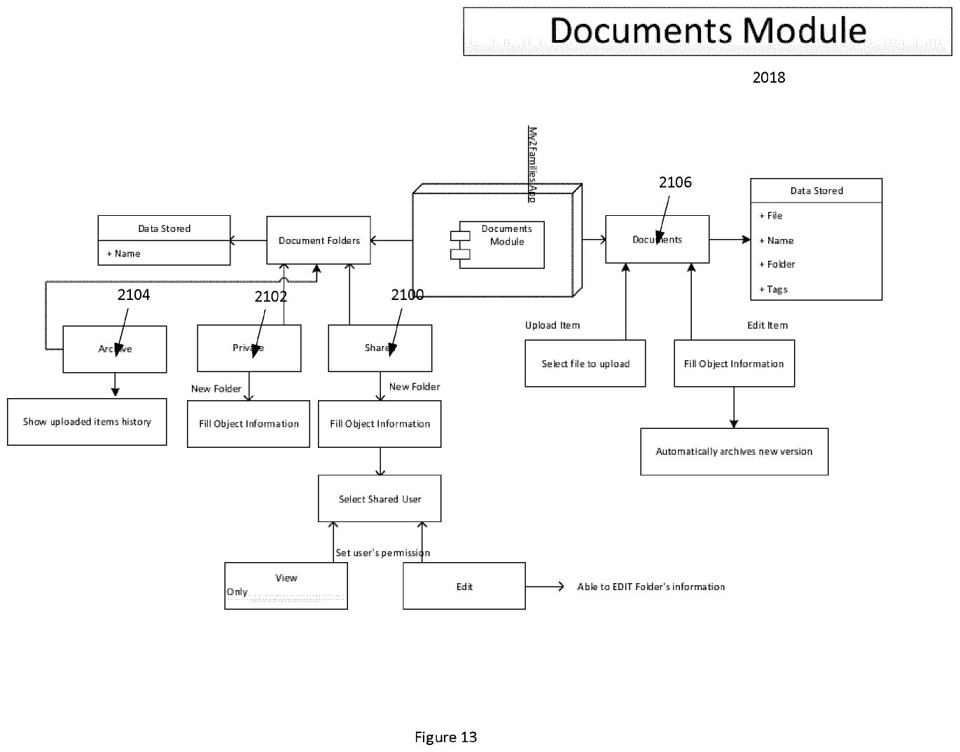

Turning to FIG. 13, a schematic diagram of one embodiment of a documents module 2018 is shown. The documents module 2018 is similar to the media center module except that the documents module stores documents instead of media. The documents module 2018 includes a shared documents folder 2100, a private documents folder 2102, an archived documents folder 2104 or as a shared document 2106.

The shared documents folder 2100 is a folder that can be accessed by any of the users and includes documents for viewing by these users. The private documents folder 2102 is a folder that includes documents that can only be viewed by a single user, or selectively shared with designated users. The shared documents 2106 are individual documents that are viewable by a user but does not belong to any shared folder accessible by the user. The archived documents folders 2104 are folders that include previous versions of stored documents. In one embodiment, when a user uploads a document, it is stored in a folder as determined by the user and a copy of the document may be stored in the archived document folder as well.

One advantage of the system for family management include, but are not limited to, the ability for family law professionals to monitor progress or status of different families within a single system with a single login. Another advantage of the system is the ability to split expenses between co-parents and to monitor payment or to automate re-payment between co-parents where necessary. The system may also be able to provide reports relating to issues between the co-parents based on information stored within the system.

Another advantage of the family management system is the storage of archived transactions, expenses or matters so both co-parents are aware of any financial transactions or changes to the family calendar, in a fair and responsible manner. The system keeps a transaction record so both co-parents have the same information while allowing each parent to separately manage their user records. This system is quite unique to family law and co-parenting. The archived information is also accessible to the family law professionals, as needed. Furthermore, archiving of user transactions and transactions created by the other users within the system allows for a permanent record system that can be monitored or reviewed by external parties.

In the present disclosure, all terms referred to in singular form are meant to encompass plural forms of the same. Likewise, all terms referred to in plural form are meant to encompass singular forms of the same. Unless defined otherwise, all technical and scientific terms used herein have the same meaning as commonly understood by one of ordinary skill in the art to which this disclosure pertains.

Embodiments of the disclosure or elements thereof, such as, for example, the RBSI, the money management system, the parenting schedule system, My2Families, or the like may be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the embodiments can also be stored on the machine-readable medium. The instructions stored on the machine-readable medium can be executed by a processor or other suitable processing device and can interface with circuitry to perform the described tasks.

The particular embodiments disclosed above are illustrative only, as the present disclosure may be modified and practiced in different but equivalent manners apparent to those skilled in the art having the benefit of the teachings herein. Although individual embodiments are discussed, the disclosure covers various combinations of those embodiments and an element from one embodiment may be used in another embodiment. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the claims. If there is any conflict in the usages of a word or term in this specification and one or more patent(s) or other documents that may be incorporated herein by reference, the definitions that are consistent with this specification should be adopted.

Many variations of the embodiments set out herein will suggest themselves to those skilled in the art in light of the present disclosure. Such variations are intended to be within the scope of the appended claims.

We claim:

1. A method of managing family law obligations comprising:
receiving a settlement agreement;
determining payment details based on the settlement agreement; and
issuing an insurance policy based on the payment details.

2. The method of claim 1 wherein determining payment details based on the settlement agreement comprises:
calculating a rebalancing beneficiaries support insurance (RBSI) payment schedule.

3. The method of claim 2 further comprising:
updating the RBSI payment schedule on a regular basis or in response to actions being performed.

4. The method of claim 3 wherein the regular basis is weekly, monthly, bi-annually or annually.

5. The method of claim 3 wherein actions being performed comprise payments not made, removal of beneficiary from the settlement agreement or new expenses associated with the settlement agreement.

6. The method of claim 1 further comprising:
issuing an irrevocability waiver; and
receiving a signed irrevocability waiver.

7. The method of claim 6 further comprising:
monitoring status of the insurance policy;
determining expiry of beneficiary support; and
notifying a policy owner that the insurance policy may be updated.

8. The method of claim 1 further comprising:
monitoring status of the insurance policy; and
determining a payment for the insurance policy has been missed.

9. The method of claim 8 further comprising:
notifying policy owner of missed payment.

10. The method of claim 8 further comprising:
notifying support beneficiary of missed payment.

11. The method of claim 1 further comprising:
monitoring status of the insurance policy;
receiving payment from a policy owner; and
displaying payment within system for users to view.

12. The method of claim 1 further comprising, before receiving a settlement agreement:
receiving financial details from a user;
calculating a set of preliminary total support amounts; and
transmitting the set of preliminary support amounts to the user.

13. A system for managing separated families comprising:
a calendar module for displaying family member schedules enabling family members to co-ordinate schedules; and a money manager module for providing an overview of all expenses for all family members.

14. The system of claim 13 wherein the money manager module comprises:
a reimbursement module for tracking payments between family members; and
an expenses module for creating expenses to be viewed by selected family member.

15. The system of claim 13 wherein the money manager module tracks expenses and payments between family members.

16. The system of claim 13 further comprising at least one of a contacts module, a children's information module, a school planner module, a notes module, a homework manager module, a media center module and a documents module.

17. The method of claim 2 wherein calculating the RBSI schedule comprises:
determining an amount of time children spend with each parent; and
calculating the RBSI schedule on the amount of time children spend with each parent.

18. The method of claim 17 wherein information relating to the amount of time children spend with each parent is retrieved from a family management system.
